(19) United States
(12) Patent Application Publication
(10) Pub. No.: US 2003/0202098 A1
(43) Pub. Date: Oct. 30, 2003

(54) Electric infrared filtered anti theft device

(76) Inventor: Kent Hsieh, Chupei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/423,875

(22) Filed: Apr. 28, 2003

(30) Foreign Application Priority Data
Apr. 29, 2002 (CN) 02211544.7

(51) Int. Cl. H04N 7/18

(52) U.S. Cl. 348/151

(57) ABSTRACT

The invention provides an electric multi-layered infrared filtered anti theft device. The camera is responsive to visible and near-infrared spectrum by using a double-layered Infrared Filter. The first layer is a near-infrared filter for a monitoring device. The filter can be switched to in front of or behind the camera lens, in order to block visible light and allow near-infrared light to pass through, otherwise, both lights could come through. As for the second layer, its method uses a filter partition that is penetrate-able by infrared. When there is more visible light than near-infrared light, the camera is only responsive to visible light; when there is more near-infrared than visible light, the camera is only responsive to near-infrared. Having the advantages mentioned above, this device can take different pictures according to multiple different environments, in order to achieve secret and disguised monitoring.

### BACKGROUND OF THE INVENTION

1. Field of the Invention

The present invention relates to an anti-theft device. More specifically, the present invention discloses an electric infrared filter anti theft device comprising a multiple-layered near-infrared filter responsive to visible light and near-infrared light with infrared filters in order to monitor in a disguised or secret environment.

2. Description of the Prior Art

Conventional color cameras that are responsive to visible and infrared light that are on the market can transfer visible light into a color image when there is enough daylight. However, when there is not enough light, they transfer near-infrared into a color image.

When applying these products to anti theft locations, one camera is needed for each room. This requires an expensive cost, which in most situations is too high. Alternatively, these cameras require the use of transparent windows and non-transparent curtains as partitions where the camera can see through the transparent window and into a second area. However, when monitoring is needed the curtains must be opened. This is not convenient and does not allow stealth monitoring.

As seen by the above description, these current products are inconvenient, and are not considered as a good design or solution. Therefore, there is much improvement to be made to overcome the disadvantages of the current products.

Therefore, there is need for an anti-theft camera monitoring device capable of disguised monitoring of multiple locations with a single camera.

### SUMMARY OF THE INVENTION

To achieve these and other advantages and in order to overcome the disadvantages of the conventional method in accordance with the purpose of the invention as embodied and broadly described herein, the present invention provides an electric multiple-layered near-infrared filter anti theft device comprising a double-layered near-infrared filter responsive to visible light and near-infrared light with two layers of near-infrared filters in order to monitor in a disguised or secret environment.

An object of the present invention is to provide areas with high security demands, such as, financial institutions or banks with a highly reliable and highly secure means of monitoring multiple locations. The invention is particularly suitable for locations where it is not practical or convenient for having too many curtains or cameras. In these locations, if the security cameras are exposed, they are easily damaged by intruders and rendered unusable. If an intruder damages exposed cameras, the hidden cameras can be activated at once in order to record the situation in secrecy.

Another object of the present invention is to provide offices with large open spaces with an electric double-layered infrared filter anti theft camera. These offices typically have office partitions that are of human height, and where the camera is required to penetrate more than one room. In doing so, the device can avoid an intruders' attention, in order to monitor in secrecy.

Finally, another object is to provide an electric double-layered infrared filter anti theft camera for educational uses at school. Leveraging students' curiosity to learn the physical characteristics of infrared will enhance students' memory and interests.

According to the advantages mentioned above, the electric double-layered infrared filter anti theft camera of the present invention basically comprises a filter barricade for a camera lens, and a double-layered infrared partition.

The rotary disk barricade for the camera lens further comprises a CCD camera, which is responsive to the visible and near-infrared spectrum. The rotary disk barricade is placed in front of the camera lens. The rotary disk further comprises an infrared filter and a piece of transparent glass. The rotary disk barricade is used to determine whether the picture needs to be taken with or without the filter. The barricade is powered by a continuous current mini motor. The exact position of the rotary disk is stored in the memory of the control circuit.

The partition that is penetrate-able by infrared is made of a plate that is penetrate-able by infrared. The material of the infrared plate is plated mediator or glass-ceramics. The plated mediator is a thin film that is steam or evaporator plated on transparent glass. The glass-ceramics is like glass as well as metal. It is glass-based and is combined with different types of crystallizations. Since the size of the crystals is very small (0.1-0.01 μm) and random, the glass-ceramics appears to be smoother than traditional ceramics. Its outstanding characteristic is that it is completely opaque, but is totally transparent for infrared.

The plated mediator of the plated protection layer is plated again with a thin film of diamond film, in order to protect the layer from damage. Diamond plated film is an excellent infrared mediator in optics. It can grow on Silicon, Germanium or Quartz, etc. and is suitable for being used as an infrared mediator and protects and reduces the reflected image layers. The ideal mono-crystal diamond is transparent out of the infrared spectrum between 1-30 μm.

When the rotary disk is switched to the front of the lens, the light that comes into the lens is only near-infrared. Therefore, the camera can take pictures of multiple rooms at the same time. The image transferred from the CCD camera to the monitor is black and white and caused by near-infrared light. The visible light of a first room is blocked by the near-infrared filter, and the near-infrared filter of the partition blocks the visible light in Room A2

Therefore, the present invention provides an anti-theft camera monitoring device capable of disguised monitoring of multiple locations with a single camera.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an electric multi-layered near-infrared filter anti theft device according to an embodiment of the present invention;

FIG. 2A is a diagram illustrating an electric multi-layered near-infrared filter anti theft device with an IR pass filter in front of the lens according to an embodiment of the present invention;

FIG. 2B is a diagram illustrating an electric multi-layered near-infrared filter anti theft device with an IR pass filter in back of the lens according to an embodiment of the present invention;

FIG. 3A is a diagram illustrating an electric multi-layered near-infrared filter anti theft device according to an embodiment of the present invention;

FIG. 3B is a diagram illustrating an electric multi-layered near-infrared filter anti theft device with IR source according to an embodiment of the present invention;

FIG. 4 is a diagram illustrating an electric multi-layered near-infrared filter anti theft device according to an embodiment of the present invention; and

FIG. 5 is a diagram illustrating an electric multi-layered near-infrared filter anti theft device according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

According to the advantages mentioned above, the electric multi-layered infrared filter anti theft device of the present invention basically comprises a rotary disk barricade for a camera lens, and a double-layered infrared partition.

The rotary disk barricade for the camera lens further comprises a CCD camera, which is responsive to the visible and near-infrared spectrum. The rotary disk barricade is placed in front of the camera lens. The rotary disk further comprises an infrared filter and a piece of transparent glass. The rotary disk barricade is used to determine whether the picture needs to be taken with or without the filter. The barricade is powered by a continuous current mini motor. The exact position of the rotary disk is stored in the memory of the control circuit.

The partition that is penetrate-able by infrared is made of a plate that is penetrate-able by infrared. The material of the infrared plate is plated mediator or glass-ceramics. The plated mediator is a thin film that is steam or evaporator plated on transparent glass. The glass-ceramics is like glass as well as metal. It is glass-based and is combined with different types of crystallizations. Since the size of the crystals is very small (0.1-0.01 μm) and random, the glass-ceramics appears to be smoother than traditional ceramics. Its outstanding characteristic is that it is completely opaque, but is totally transparent for infrared.

The plated mediator of the plated protection layer is plated again with a thin film of diamond film, in order to protect the layer from damage. Diamond plated film is an excellent infrared mediator in optics. It can grow on Silicon, Germanium or Quartz, etc. and is suitable for being used as an infrared mediator and protects and reduces the reflected image layers. The ideal mono-crystal diamond is transparent out of the infrared spectrum between 1-30μm.

The theory of the double-layered near-infrared filter is as followings:

A camera is placed in a room to monitor subjects. In an adjoining room is another subject. The rooms are separated by a partition. In the conventional setup, only the subjects in room can be monitored and the subject in cannot be monitored.

For an electric multiple-layered near-infrared filter anti theft device according to an embodiment of the present invention, the following example is given.

The CCD camera is a highly sensitive camera that is responsive to visible and near-infrared light. It can take color pictures when there is enough daylight and when there is not enough light, it takes black and white pictures or movies.

The camera is placed in the first room. Between the first and second room, there is a material that is penetrate-able by infrared as glass partition. In order to clearly explain, suppose that there is enough light in room one and Room two during the daytime. Also, suppose that in Room one, there are visible light and near-infrared light; and in Room two, there are visible light, and near-infrared light.

Initially, without filtering, the CCD camera is facing the partition. The light that comes into the camera lens equals visible light room 1+near-infrared light room 1+near-infrared light room 2, since visible light room 2 is blocked by the partition. In room 1 the amount of visible light is far greater than IR room 1+IR room 2. Therefore, the CCD camera can only take pictures of Room 1. The image then transferred from CCD camera to the monitor is a color image caused by visible light.

When the filter disk is switched to the front of the lens, the light that comes into the lens equals IR room 1+IR room 2. Therefore, the camera can take pictures of room 1 and room 2 at the same time. The image transferred from the CCD camera to the monitor is black and white and caused by near-infrared light. The visible light of room 1 is blocked by the near-infrared filter, and the near-infrared filter of the partition blocks the visible light in room 2.

Using the filtering techniques of the present invention allows subjects in multiple rooms separated by a partition, to be effectively monitored with a single camera.

The electric multi-layered infrared filter CCD Camera is an anti-theft camera that comprises a CCD camer, a mini continuous current motor, a near-infrared filter and infrared light source in the housing. A user can choose to switch the near-infrared filter to the front of the camera lens or in back of the lens, in order to monitor more rooms behind Room 1. In order not to be found and destroyed by intruders, the camera can be placed in secrecy, so that it can monitor in safety. In the camera housing, there is an infrared light source to overcome the challenges of monitoring in the dark.

In the previously described embodiments, the filter has been described as being placed in front of the lens. However, in other embodiments of the present invention, the filter is placed behind the lens and offers the same advantages as when placed in front of the lens.

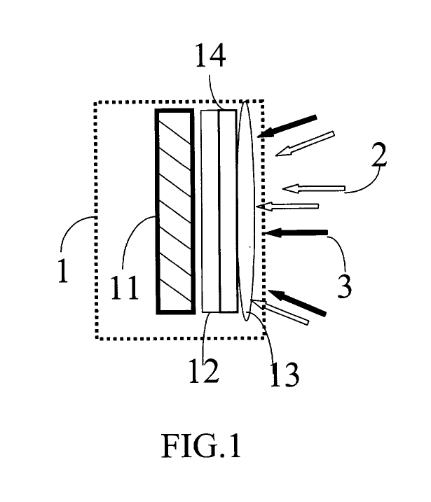

Refer to FIG. 1, which is a diagram illustrating an electric multi-layered near-infrared filter anti theft device according to an embodiment of the present invention.

The device 1 comprises an image sensor 11, a transparent glass 12, for example SiO2, which evenly distributes visible light across the image sensor, an IR cut filter 14, and a lens 13.

In this example, both visible light 2 and IR light 3 are present in front of the lens. However, the IR cut filter 14 eliminates the IR light 3 so that only the visible light 2 is captured by the image sensor.

The visible light spectrum is approximately 0.4-0.7 μm and the IR spectrum is approximately 0.7-1.2 μm. During daytime use, the IR light will cause color images to become redder in color. Therefore, the IR cut filter 14 is implemented to reduce the IR light.

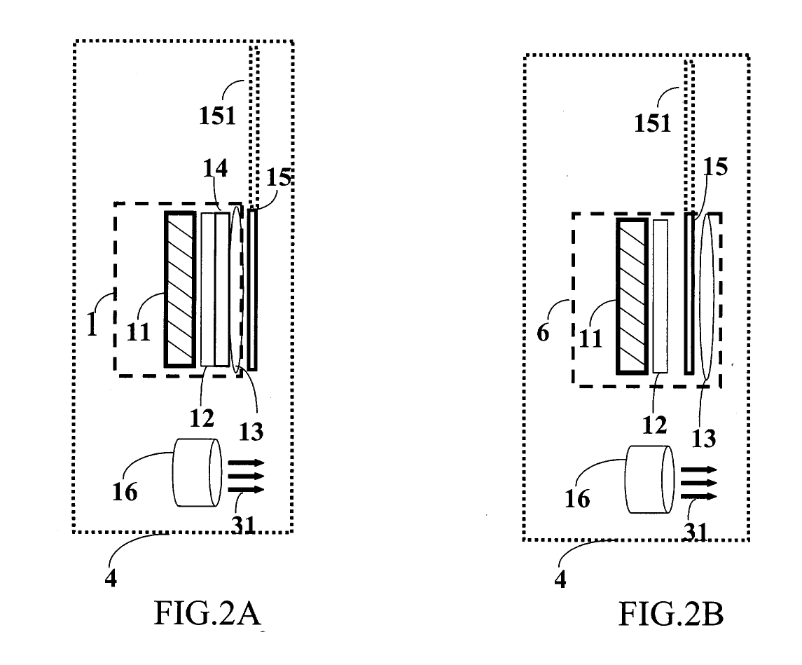

Refer to FIG. 2A, which is a diagram illustrating an electric multi-layered near-infrared filter anti theft device with an IR pass filter in front of the lens according to an embodiment of the present invention and FIG. 2B, which is a diagram illustrating an electric multi-layered near-infrared filter anti theft device with an IR pass filter in back of the lens according to an embodiment of the present invention.

In FIG. 2A, an IR source 16 emitting IR light 31 is contained in a housing 4 along with the camera 1. Furthermore, an IR pass filter 15 controlled by a motor control assembly which allows automatic adjustment and positioning of the IR pass filter 15. Therefore, the IR pass filter 15 can be moved in front of the lens 13 to take effect or move out of position 151.

In FIG. 2B, the IR pass filter 15 is positioned behind the lens 13 of the camera 6. In this embodiment, no IR cut filter is required.

For more clarity, a few practical examples of application are illustrated.

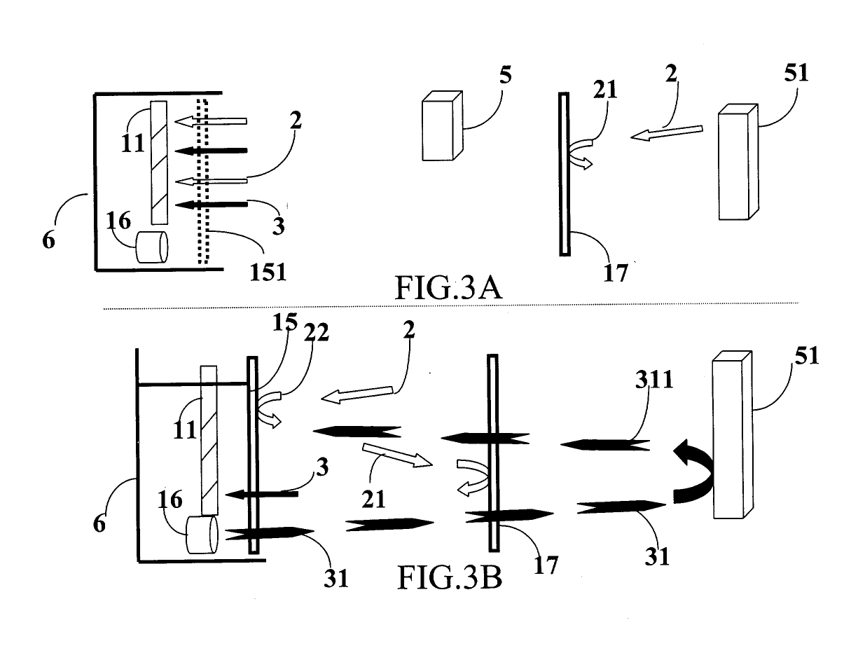

Refer to FIG. 3A, which is a diagram illustrating an electric multi-layered near-infrared filter anti theft device according to an embodiment of the present invention;

For clarity, the camera 6 is only shown with the image sensor 11, IR source 16, and out of position IR pass filter 151. The transparent glass 12 and lens 13 are still utilized, but not shown in the illustration.

In this example, a subject 5 is located in a first room and a second subject 51 is located in another room separated by an IR penetrate-able partition 17. The visible light 2 in the second room is reflected 21. Since the IR pass filter is not in position 151, both the visible light 2 and IR light of the first room are captured by the image sensor 11. Therefore, the subject 51 in the second will not be monitored.

Refer to FIG. 3B, which is a diagram illustrating an electric multi-layered near-infrared filter anti theft device with IR source according to an embodiment of the present invention.

In this example, the IR pass filter 15 is positioned in place and the IR source 16 is turned on and emits an IR light 31. The visible light 2 in the first room is reflected 22 by the IR pass filter and reflected 21 by the IR penetrate-able partition 17. The IR light 31 from the IR source 16 penetrates the IR penetrate-able partition 17 and is reflected 311 by the subject 51 in the second room. Therefore, the IR light 3 passes through the IR pass filter 15 and is captured by the image sensor 11.

Therefore, the subject 51 in the second room can be monitored by the camera 6 in the first room. Also, any subjects in the first room will also be monitored.

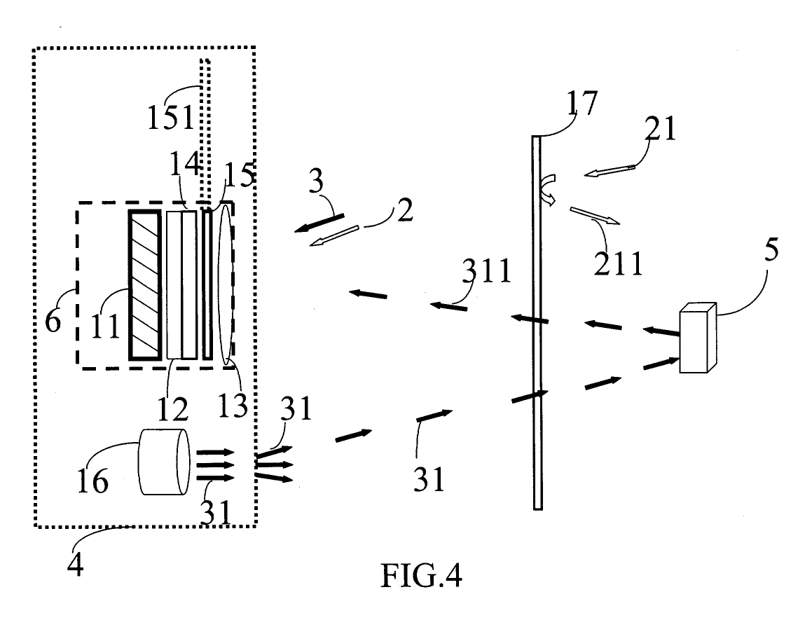

Refer to FIG. 4, which is a diagram illustrating an electric multi-layered near-infrared filter anti theft device according to an embodiment of the present invention.

FIG. 4 illustrates more clearly the lighting properties of FIG. 3B. In FIG. 4, the IR light 31 from the IR source 16 penetrates the IR penetrate-able partition 17 and is reflected 311 by the subject 51 and returns back through the IR penetrate-able partition 17. The visible light 21 in the second room is reflected 211 by the IR penetrate-able partition.

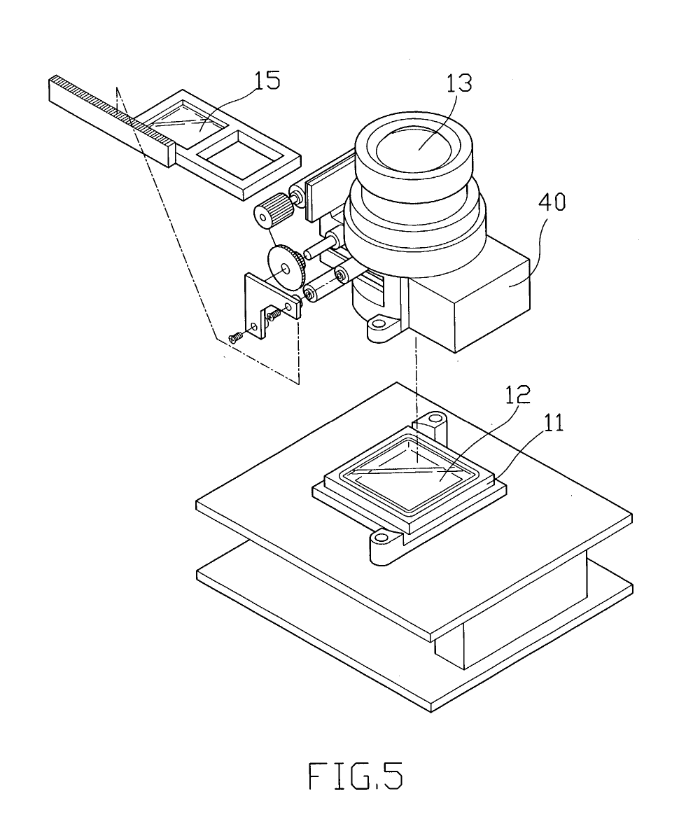

FIG. 5 is a diagram illustrating an electric multi-layered near-infrared filter anti theft device according to an embodiment of the present invention.

The three dimensional drawing of FIG. 5 illustrates the automatic motorized shuttering mechanism of an embodiment of the present invention.

The IR pass filter 15 is encased in a housing. The same housing also has an empty pane. When the IR pass filter 15 is not needed, it is retracted by the motor and gear assembly 40. When required, the motor gear assembly 40 moves the IR pass filter 15 into position behind the lens 13.

Note this embodiment illustrates a gear driven sliding mount filter housing. However, in other embodiments, the action of movement is rotary. Alternatively, the IR pass filter 15 is positioned in front of the lens in other embodiments.

Furthermore, the IR cut filter can be placed into a similar housing as the IR pass filter and can be motor driven to automatically move into position or out of position based upon need.

Some advantages of the electric multi-layered infrared filter anti theft camera of the present invention are:

1. When intruders damage or destroy the cameras that are exposed, the CCD camera, starts recording the situation immediately and is hidden from view in secrecy.

2. In offices with big open spaces, it is sometimes necessary to be able to penetrate several rooms at the same time, so that the camera can easily avoid intruder's attention and monitor in privacy.

3. In education, the device leverages students' curiosity to learn the physical characteristics of infrared and enhances students' memory and interests.

Therefore, the present invention provides an anti-theft camera monitoring device capable of disguised monitoring of multiple locations with a single camera. In this way, institutions or businesses that require a highly secure environment can be protected and will not have their security systems exposed or vulnerable. As a result, they can protect their investments in complete privacy without exposed monitoring equipment.

Numerous embodiments have been illustrated herein. However, other embodiments of the present invention utilize a motor controlled shutter for sliding or rotating the IR pass filter into place. Also, the IR pass filter can be implemented similarly so can be selectively enabled. Both of these filters can be manually or automatically controlled.

Additionally, as mentioned previously, the positioning of the IR pass filter may be in front of the lens or behind the lens. Furthermore, the IR source can be contained in a housing along with the camera or separate.

Finally, the examples have only illustrated a few rooms in the examples, however, the present invention is capable of monitoring a plurality of rooms, for example 20 rooms, that are separated by IR penetrate-able partitions. Whereby the IR light can penetrate the partitions and return through the partitions after reflecting off subjects in other rooms and finally captured by the camera.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A multi-layered near-infrared filter anti-theft device comprising:
a monitoring apparatus comprising a near-infrared filter attached to a camera lens;
a control circuit for controlling the near-infrared filter; and
an infrared penetrate-able partition for blocking visible light and allowing infrared light to pass through.

2. The multi-layered near-infrared filter anti-theft device of claim 1, wherein the near-infrared filter is placed in front of the camera lens.

3. The multi-layered near-infrared filter anti-theft device of claim 1, wherein the near-infrared filter is placed behind the camera lens.

4. The multi-layered near-infrared filter anti-theft device of claim 1, wherein the near-infrared filter is automatic.

5. The multi-layered near-infrared filter anti-theft device of claim 1, wherein the near-infrared filter is manual.

6. The multi-layered near-infrared filter anti-theft device of claim 1, wherein the near-infrared filter of the monitoring apparatus comprises more than one center of wavelength in order to satisfy different environments.

7. The multi-layered near-infrared filter anti-theft device of claim 1, wherein the materials of the near-infrared filter and the near-infrared penetrate-able partition are responsive to infrared wavelengths between 760-950 μm.

8. The multi-layered near-infrared filter anti-theft device of claim 1, wherein the infrared penetrate-able filter comprises a plated film on transparent glass.

9. The multi-layered near-infrared filter anti-theft device of claim 1, further comprising a protection layer to reinforce the near-infrared penetrate-able partition.

10. The multi-layered near-infrared filter anti-theft device of claim 9, wherein the protection layer comprises diamond.

11. The multi-layered near-infrared filter anti-theft device of claim 1, wherein, the infrared penetrate-able partition comprises material that is responsive to near-infrared wavelength, or color visible light.

12. The multi-layered near-infrared filter anti-theft device of claim 1, wherein in the monitor structure, there is more than one wavelength of near-infrared filter.

13. The multi-layered near-infrared filter anti-theft device of claim 1, further comprising an infrared light source.

14. An multi-layered near-infrared filter anti-theft device comprising:
a monitoring apparatus comprising a near-infrared filter attached to a camera lens; and
an infrared penetrate-able partition for blocking visible light and allowing infrared light to pass through.

15. The multi-layered near-infrared filter anti-theft device of claim 14, wherein the near-infrared filter is placed in front of the camera lens.

16. The multi-layered near-infrared filter anti-theft device of claim 14, wherein the near-infrared filter is placed behind the camera lens.

17. The e multi-layered near-infrared filter anti-theft device of claim 14, further comprising a control circuit for automatically controlling the near-infrared filter.

18. The multi-layered near-infrared filter anti-theft device of claim 14, wherein the near-infrared filter of the monitoring apparatus comprises more than one center of wavelength in order to satisfy different environments.

19. The multi-layered near-infrared filter anti-theft device of claim 14, wherein the materials of the near-infrared filter and the near-infrared penetrate-able partition are responsive to infrared wavelengths between 760-950 μm.

20. The multi-layered near-infrared filter anti-theft device of claim 14, wherein the infrared penetrate-able filter comprises a plated film on transparent glass.

21. The multi-layered near-infrared filter anti-theft device of claim 14, further comprising a protection layer to reinforce the near-infrared penetrate-able partition.

22. The multi-layered near-infrared filter anti-theft device of claim 21, wherein the protection layer comprises diamond.

23. The multi-layered near-infrared filter anti-theft device of claim 14, wherein, the infrared penetrate-able partition comprises material that is responsive to near-infrared wavelength, or color visible light.

24. The multi-layered near-infrared filter anti-theft device of claim 14, wherein in the monitor structure, there is more than one wavelength of near-infrared filter.

25. The multi-layered near-infrared filter anti-theft device of claim 14, further comprising an infrared light source.
